(19) United States
(12) Patent Application Publication
(10) Pub. No.: US 2004/0089108 A1
(43) Pub. Date: May 13, 2004

(54) Wrench having a locking device with a smaller driving angle

(76) Inventor: Chuck Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/382,531

(22) Filed: Mar. 7, 2003

(30) Foreign Application Priority Data
Nov. 11, 2002 (TW) 091218180

(51) Int. Cl. B25B 13/46

(52) U.S. Cl. 81/62

(57) ABSTRACT

A wrench includes a drive head, a drive member, a plurality of locking teeth mounted on either one of the inner wall of the drive head and the drive member, and a locking device mounted on either one of the inner wall of the drive head and the drive member. The locking device includes at least two driving blocks each formed with a locking end engageable with the locking teeth to drive the drive member. The locking ends of the at least two driving blocks are respectively engaged with the locking teeth at different time. Thus, the locking device has a smaller driving angle for driving the drive member.

### BACKGROUND OF THE INVENTION

1. Field of the Invention

The present invention relates to a wrench having a locking device with a smaller driving angle, and more particularly to a wrench having a locking device including at least two composite driving blocks having different lengths to lock and drive the drive member at different angles, so that the locking device has a smaller driving angle for driving the drive member.

2. Description of the Related Art

A first conventional ratchet wrench 90 in accordance with the prior art shown in FIG. 19 comprises a drive head 92 formed with a receiving recess 920 and a driving recess 921 located beside the receiving recess 920, a ratchet wheel 93 mounted in the receiving recess 920, two locking blocks 95 mounted in the driving recess 921, an urging block 94 mounted in the driving recess 921 and urged on one of the two locking blocks 95, two restoring members 96 mounted in the driving recess 921 and urged on a respective one of the two locking blocks 95, and a direction control knob 940 pivotably mounted on the drive head 92 and connected to the urging block 94 for rotating the urging block 94 to control the driving direction of the two locking blocks 95. However, the locking blocks 95 of the first conventional ratchet wrench 90 do not have a smaller driving angle.

A second conventional ratchet wrench 90A in accordance with the prior art shown in FIG. 20 comprises a drive head 92A having an inner wall formed with a plurality of locking teeth 920A, a drive member 93A mounted in the drive head 92A, and a locking block 95A pivotally mounted in the drive member 93A and engaged with the locking teeth 920A of the drive head 92A. However, the locking block 95A of the second conventional ratchet wrench 90A do not have a smaller driving angle.

### SUMMARY OF THE INVENTION

The present invention is to mitigate and/or obviate the disadvantage of the conventional ratchet wrench.

The primary objective of the present invention is to provide a wrench, wherein the locking device includes at least two composite driving blocks having different lengths to lock and drive the drive member at different angles, so that the locking device has a smaller driving angle for driving the drive member, thereby enhancing the torque of the wrench with a smaller driving angle.

Another objective of the present invention is to provide a wrench having a simplified construction without having to changing the structure of the drive member, the drive head and the direction control knob, thereby decreasing costs of fabrication and maintenance.

A further objective of the present invention is to provide a wrench, wherein provision of the locking device does not affect the structural strength of the wrench, thereby enhancing the structural strength of the wrench.

In accordance with the present invention, there is provided a wrench, comprising:

a drive head;

a drive member mounted in an inner wall of the drive head;

a plurality of locking teeth mounted on either one of the inner wall of the drive head and the drive member; and

at least one locking device mounted on either one of the inner wall of the drive head and the drive member and engaged with the locking teeth to drive the drive member, wherein:

the at least one locking device includes at least two independent driving blocks laminating each other;

each of the at least two driving blocks is formed with a locking end and a positioning portion, the locking end is engageable with the locking teeth; and

the locking ends of the at least two driving blocks are respectively engaged with the locking teeth at different time.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of the wrench in accordance with the first embodiment of the present invention;

FIG. 2 is an exploded perspective view of the wrench in accordance with the first embodiment of the present invention;

FIG. 3 is a bottom perspective assembly view of the wrench in accordance with the first embodiment of the present invention;

FIG. 4 is a top plan assembly view of the wrench as shown in FIG. 2;

FIG. 5 is a top plan operational view of the wrench as shown in FIG. 2;

FIG. 5A is a schematic operational view of the wrench as shown in FIG. 5 in use;

FIG. 5B is a schematic operational view of the wrench as shown in FIG. 5A in use;

FIG. 5C is a schematic operational view of the wrench as shown in FIG. 5B in use;

FIG. 6 is a top plan assembly view of the wrench in accordance with another embodiment of the present invention;

FIG. 7 is a perspective assembly view of a locking device of the wrench in accordance with the second embodiment of the present invention;

FIG. 8 is an exploded perspective view of the locking device of the wrench as shown in FIG. 7;

FIG. 9 is an exploded perspective view of a locking device of the wrench in accordance with the third embodiment of the present invention;

FIG. 10 is a top plan view of the wrench in accordance with the fourth embodiment of the present invention;

FIG. 11 is an exploded perspective view of the wrench in accordance with the fifth embodiment of the present invention;

FIG. 12 is an exploded perspective view of the wrench in accordance with the sixth embodiment of the present invention;

FIG. 13 is an exploded perspective view of the wrench in accordance with the seventh embodiment of the present invention;

FIG. 14 is an exploded perspective view of the wrench in accordance with the eighth embodiment of the present invention;

FIG. 15 is an exploded perspective view of the wrench in accordance with the ninth embodiment of the present invention;

FIG. 16 is a top plan view of the wrench in accordance with the tenth embodiment of the present invention;

FIG. 17 is an exploded perspective view of the wrench in accordance with the eleventh embodiment of the present invention;

FIG. 18 is an exploded perspective view of the wrench in accordance with the twelfth embodiment of the present invention;

FIG. 19 is an exploded perspective view of a first conventional ratchet wrench in accordance with the prior art; and

FIG. 20 is an exploded perspective view of a second conventional ratchet wrench in accordance with the prior art.

### DETAILED DESCRIPTION OF THE INVENTION

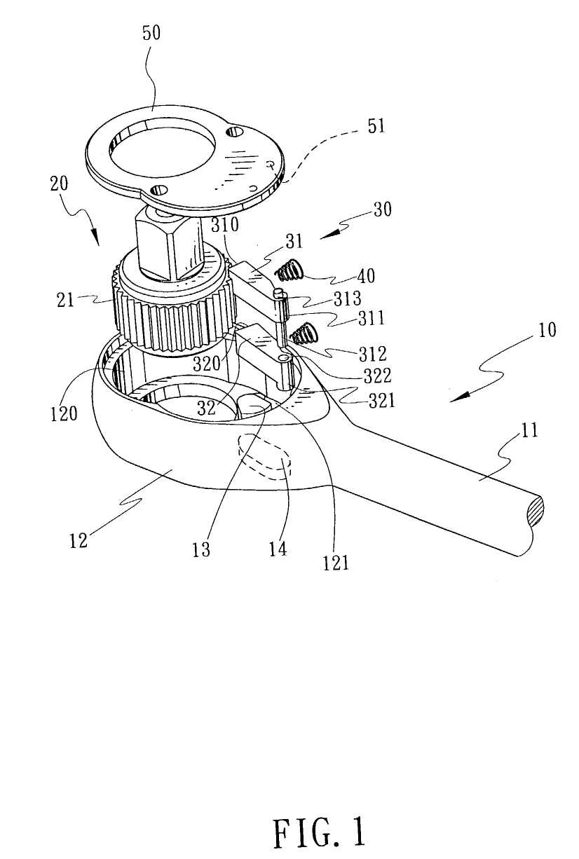

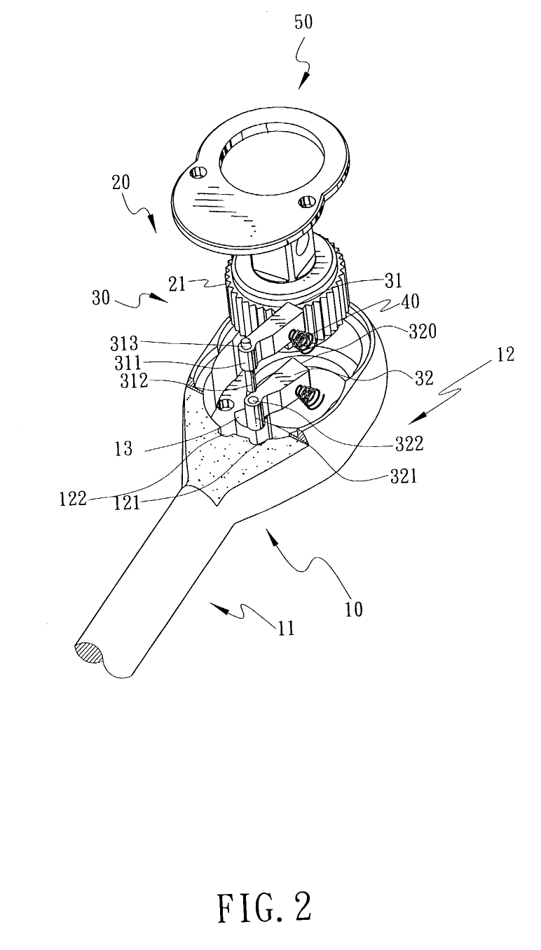

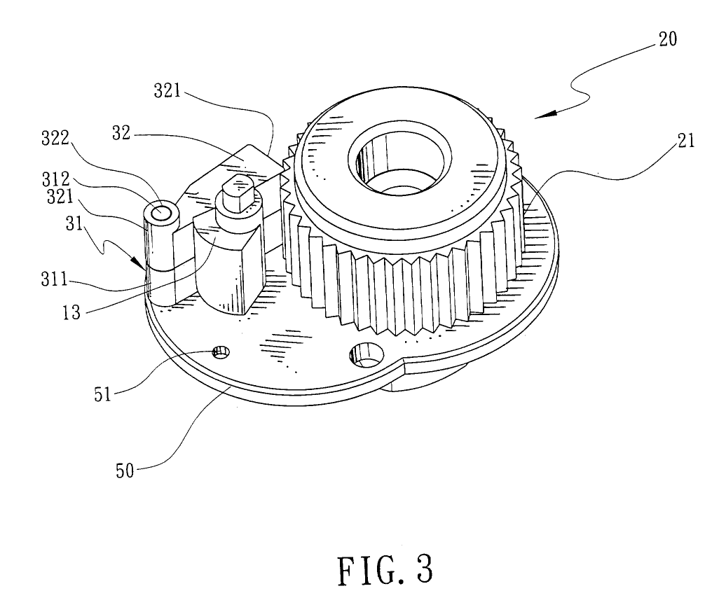

Referring to the drawings and initially to FIGS. 1-4, a wrench 10 in accordance with a first embodiment of the present invention comprises a shank 11 having an end portion formed with a drive head 12 formed with a receiving recess 120 and a driving recess 121 located beside the receiving recess 120, a drive member 20 (such as a ratchet wheel) mounted in the receiving recess 120 and having an outer wall formed with locking teeth 21, an urging block 13 mounted in the driving recess 121, two locking devices 30 mounted in the driving recess 121 and located beside the urging block 13, a plurality of restoring members 40 (such as springs) mounted in the driving recess 121 and urged on the locking device 30, a direction control knob 14 pivotably mounted on the drive head 12 and connected to the urging block 13 for rotating the urging block 13, and a cover 50 mounted in a top of the receiving recess 120 to cover the drive head 12.

The locking device 30 is located on each of two sides of the urging block 13 and includes a first driving block 31 and a second driving block 32 laminating each other.

Each of the first driving block 31 and the second driving block 32 has a first end formed with a locking end 310 and 320 engaged with the locking teeth 21 of the drive member 20. The locking end 310 of the first driving block 31 is protruded outward from the locking end 320 of the second driving block 32 with a length difference equal to a half of the tooth pitch of the locking teeth 21 of the drive member 20.

Each of the first driving block 31 and the second driving block 32 has a second end formed with a cylindrical positioning portion 311 and 321. The two positioning portions 311 and 321 are co-axial and are rotatably mounted in an arcuate positioning recess 122 in the driving recess 121. The positioning portion 321 of the second driving block 32 has a bottom locked on a bottom of the driving recess 121.

The positioning portion 321 of the second driving block 32 is formed with a pivot hole 322. The positioning portion 311 of the first driving block 31 has a bottom formed with a protruding pivot portion 312 pivotally mounted in the pivot hole 322 of the second driving block 32.

The cover 50 has a bottom formed with two mounting holes 51. The positioning portion 311 of the first driving block 31 has a top formed with a protruding mounting portion 313 mounted in one of the two mounting holes 51 of the cover 50.

Each of the restoring members 40 is urged between each of the first driving block 31 and the second driving block 32 of the locking device 30 and the wall of the driving recess 121.

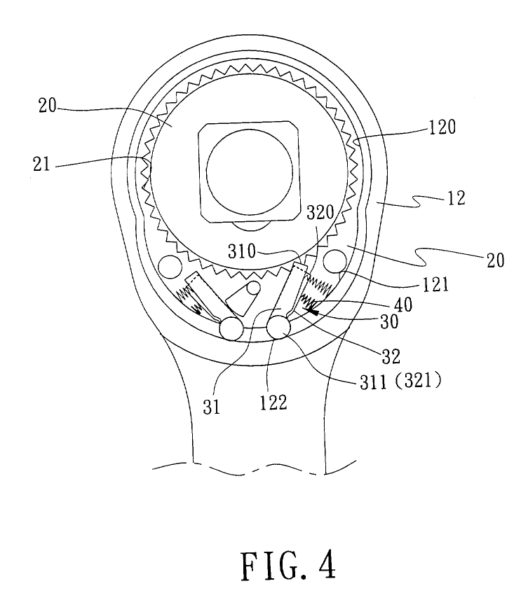

In assembly, the locking device 30 located on one of the two sides of the urging block 13 is pressed by the urging block 13 as shown in FIG. 4, so that only one of the two locking devices 30 is engaged with the drive member 20. In such a manner, when the drive head 12 is rotated, only one of the two locking devices 30 is driven to rotate the drive member 20 for rotating a workpiece (not shown) or a socket (not shown) in the clockwise or counterclockwise direction. Thus, the driving direction of the wrench 10 can be controlled by pivoting the urging block 13.

In addition, the locking end 310 of the first driving block 31 is protruded outward from the locking end 320 of the second driving block 32, so that only one of the locking end 310 of the first driving block 31 and the locking end 320 of the second driving block 32 of the locking device 30 is engaged with the locking teeth 21 of the drive member 20 for driving the drive member 20.

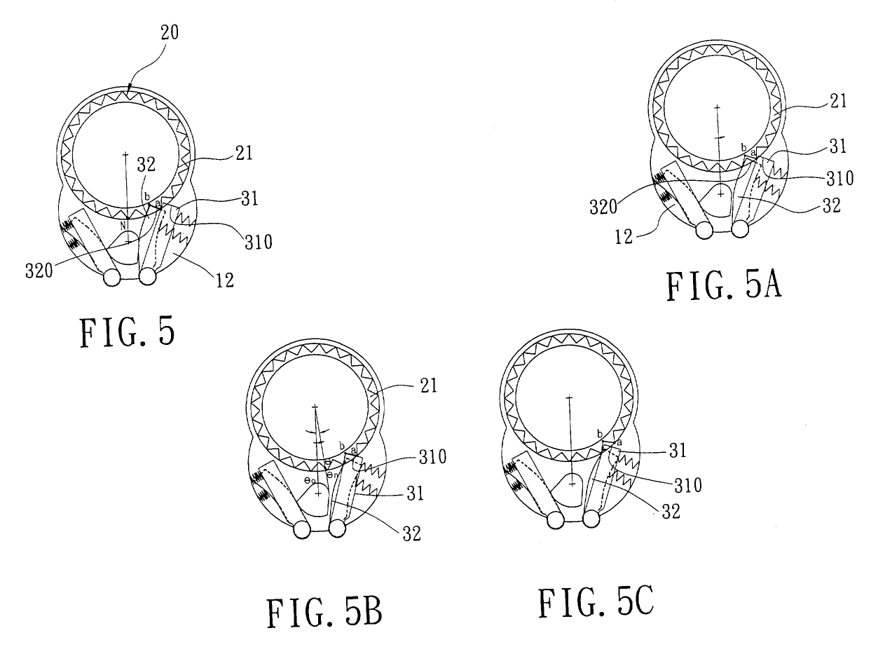

In operation, referring to FIG. 5 with reference to FIGS. 1-4, when the locking device 30 is driven to rotate the drive member 20 for rotating the workpiece or the socket, the locking end 320 of the second driving block 32 is locked on the tooth root “b” of one of the locking teeth 21 of the drive member 20 for driving the drive member 20. When the operation space of the wrench 10 is limited, the drive head 12 has to be rotated backward.

When the drive head 12 is rotated from the position as shown in FIG. 5 to the position as shown in FIG. 5A, the rotation distance is smaller than a half of the tooth pitch of the locking teeth 21 of the drive member 20, so that the locking end 320 of the second driving block 32 is detached from the tooth root “b” of one of the locking teeth 21 of the drive member 20, while the locking end 310 of the first driving block 31 is rested on the tooth tip “a” of one of the locking teeth 21 of the drive member 20.

When the drive head 12 is rotated from the position as shown in FIG. 5A to the position as shown in FIG. 5B, the locking end 310 of the first driving block 31 is detached from the tooth tip “a” of one of the locking teeth 21 of the drive member 20 and is locked on the tooth root “b” of one of the locking teeth 21 of the drive member 20. At this time, when the drive head 12 is rotated forward again, the locking end 310 of the first driving block 31 (instead of the locking end 320 of the second driving block 32) is locked on the tooth root “b” of one of the locking teeth 21 of the drive member 20 for driving the drive member 20.

When the drive head 12 is rotated from the position as shown in FIG. 5B to the position as shown in FIG. 5C, the locking end 310 of the first driving block 31 is detached from the tooth root “b” of one of the locking teeth 21 of the drive member 20, while the locking end 320 of the second driving block 32 is rested on the tooth tip of another one of the locking teeth 21 of the drive member 20.

When the drive head 12 is rotated from the position as shown in FIG. 5c to the position as shown in FIG. 5, the locking end 320 of the second driving block 32 is detached from the tooth tip of another one of the locking teeth 21 of the drive member 20 and is locked on the tooth root of another one of the locking teeth 21 of the drive member 20. At this time, when the drive head 12 is rotated forward again, the locking end 320 of the second driving block 32 (instead of the locking end 310 of the first driving block 31) is locked on the tooth root of another one of the locking teeth 21 of the drive member 20 for driving the drive member 20.

Thus, the locking end 310 of the first driving block 31 and the locking end 320 of the second driving block 32 are located at the same locking tooth 21 of the drive member 20, and only one of the first driving block 31 and the second driving block 32 is acted on the drive member 20, so that the locking device 30 has a smaller driving angle for driving the drive member 20.

Accordingly, the wrench 10 in accordance with the present invention has the following advantages.

1. The locking device 30 includes at least two composite driving blocks having different lengths to lock and drive the drive member 20 at different angles, so that the locking device 30 has a smaller driving angle for driving the drive member 20, thereby enhancing the torque of the wrench 10 with a smaller driving angle.

2. The wrench 10 has a simplified construction without having to changing the structure of the drive member 20, the drive head 12 and the direction control knob 14, thereby decreasing costs of fabrication and maintenance.

3. Provision of the locking device 30 does not affect the structural strength of the wrench 10, thereby enhancing the structural strength of the wrench 10.

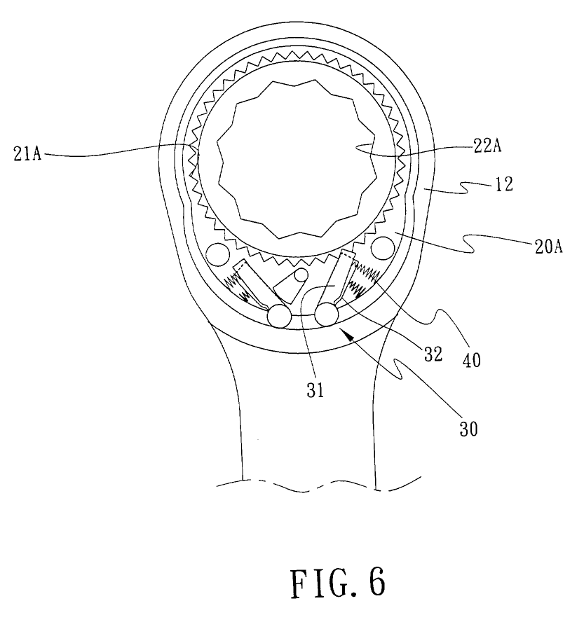

Referring to FIG. 6, in accordance with another embodiment of the present invention, the drive member 20A has an outer wall formed with locking teeth 21A and an inner wall formed with a polygonal driving recess 22A.

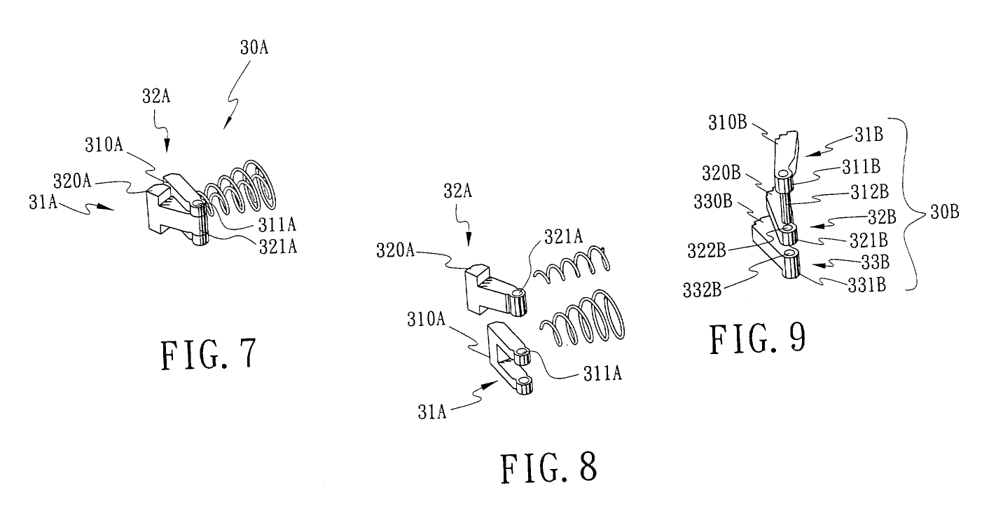

Referring to FIGS. 7 and 8, in accordance with a second embodiment of the present invention, the locking device 30A includes a first driving block 31A and a second driving block 32A laminating each other. The first driving block 31A is substantially U-shaped, and has a locking end 310A and two positioning portions 311A. The second driving block 32A is substantially T-shaped, and has a locking end 320A and a positioning portion 321A pivotally mounted between the two positioning portions 311A of the first driving block 31A.

Referring to FIG. 9, in accordance with a third embodiment of the present invention, the locking device 30B includes a first driving block 31B, a second driving block 32B and a third driving block 33B laminating each other. Each of the first driving block 31B, the second driving block 32B and the third driving block 33B has a first end formed with a toothed locking end 310B, 320B and 330B engaged with the locking teeth 21 of the drive member 20. Each of the first driving block 31B, the second driving block 32B and the third driving block 33B has a second end formed with a positioning portion 311B, 321B and 331B. The positioning portion 331B of the third driving block 33B has a bottom locked on a bottom of the driving recess 121. The positioning portion 321B and 331B of each of the second driving block 32B and the third driving block 33B is formed with a pivot hole 322B and 332B. The positioning portion 311B of the first driving block 31B has a bottom formed with a protruding pivot portion 312B pivotally mounted in the pivot hole 322B and 332B of each of the second driving block 32B and the third driving block 33B.

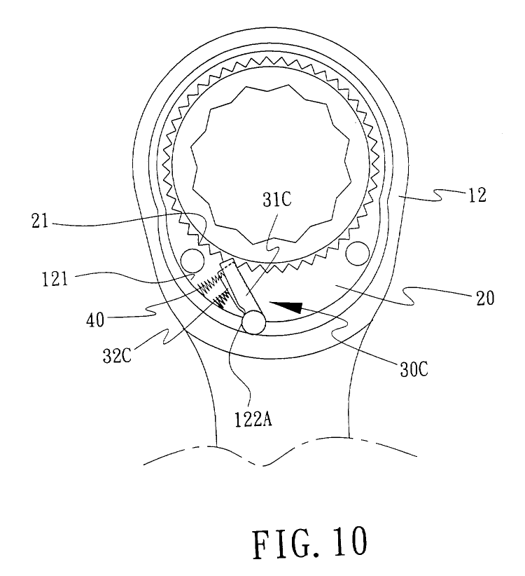

Referring to FIG. 10, in accordance with a fourth embodiment of the present invention, the wrench only comprises a locking device 30C mounted in the driving recess 121, and the urging block 13 is undefined. In addition, the locking device 30C includes a first driving block 31C and a second driving block 32C laminating each other.

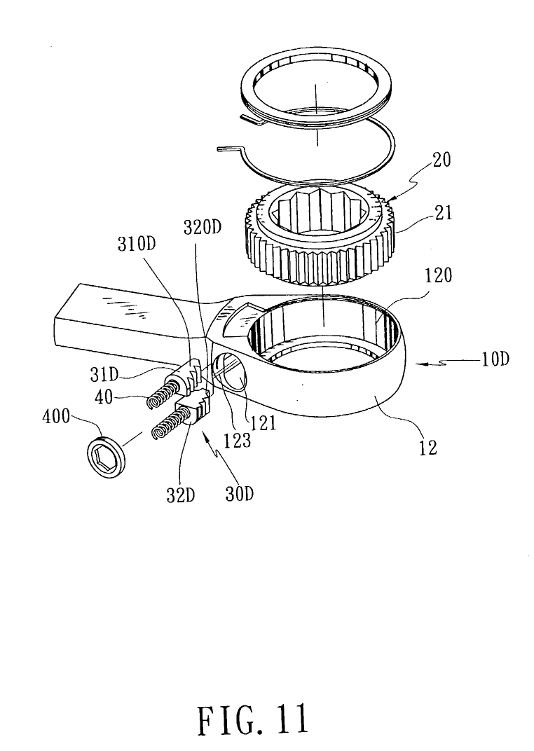

Referring to FIG. 11, in accordance with a fifth embodiment of the present invention, the wrench 10D only comprises a locking device 30D mounted in the driving recess 121, and the urging block 13 is undefined. In addition, the locking device 30D includes a first driving block 31D and a second driving block 32D laminating each other. Each of the first driving block 31D and the second driving block 32D has a first end formed with a toothed locking end 310D and 320D engaged with the locking teeth 21 of the drive member 20 and a second end urged on a restoring member 40. In addition, the wrench 10D further comprises a threaded seal cover 400 screwed into an inner thread 123 of the driving recess 121 and urged on the restoring member 40.

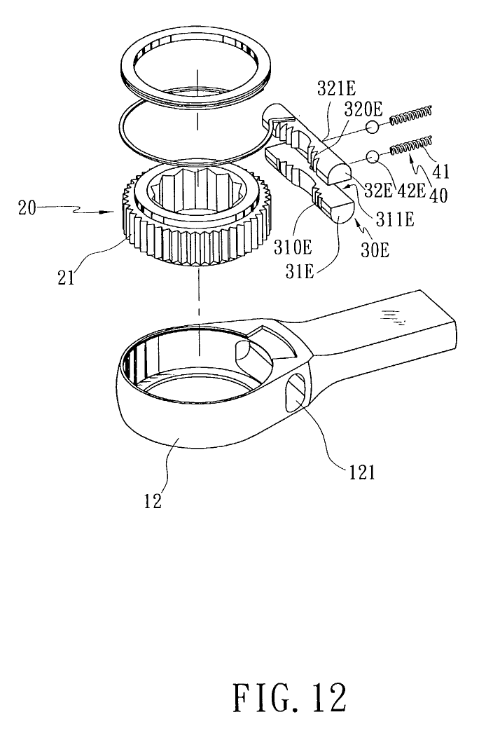

Referring to FIG. 12, in accordance with a sixth embodiment of the present invention, the wrench comprises a locking device 30E mounted in the driving recess 121. In addition, the locking device 30E includes an elongated first driving block 31E and an elongated second driving block 32E laminating each other. Each of the first driving block 31E and the second driving block 32E has a first side formed with two spaced toothed locking ends 310E and 320E engaged with the locking teeth 21 of the drive member 20 and a second side formed with a concave positioning portion 311E and 321E urged on a restoring member 40E which includes a ball-shaped push member 42E urged on the positioning portion 311E and 321E and an elastic member 41E urged on the push member 42E and the wall of the driving recess 121. Each of the first driving block 31E and the second driving block 32E has two ends each protruding outward from the driving recess 121 of the drive head 12 to facilitate the user operating the locking device 30E to change the driving direction of the wrench.

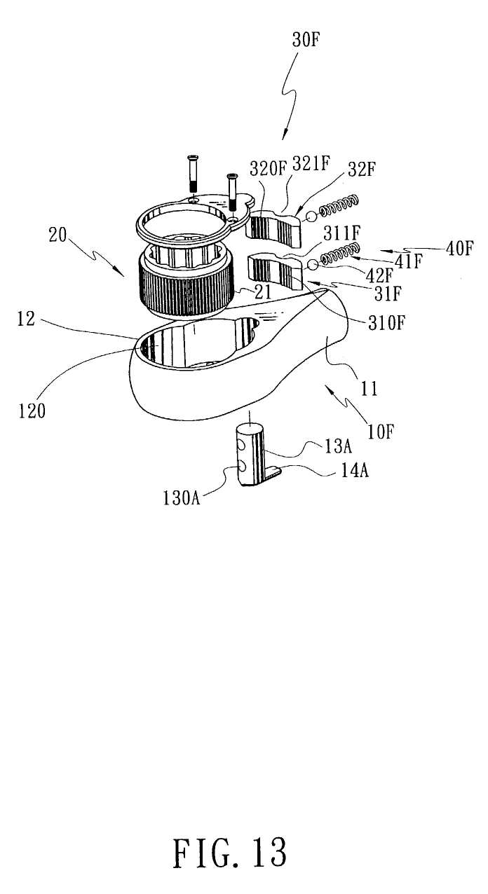

Referring to FIG. 13, in accordance with a seventh embodiment of the present invention, the wrench 10F comprises a locking device 30F mounted in the driving recess 121, an urging block 13A rotatably mounted in the driving recess 121 and formed with two receiving holes 130A, and a direction control knob 14A pivotably mounted on the drive head 12 and secured on the urging block 13A for rotating the urging block 13A. In addition, the locking device 30F includes a first driving block 31F and a second driving block 32F laminating each other. Each of the first driving block 31F and the second driving block 32F has a first side formed with two spaced toothed locking end 310F and 320F engaged with the locking teeth 21 of the drive member 20 and a second side formed with a concave positioning portion 311F and 321F urged on a restoring member 40F which is received in a respective one of the two receiving holes 130A of the urging block 13A and includes a ball-shaped push member 42F urged on the positioning portion 311F and 321F and an elastic member 41F urged on the push member 42F and the wall of the respective receiving hole 130A of the urging block 13A.

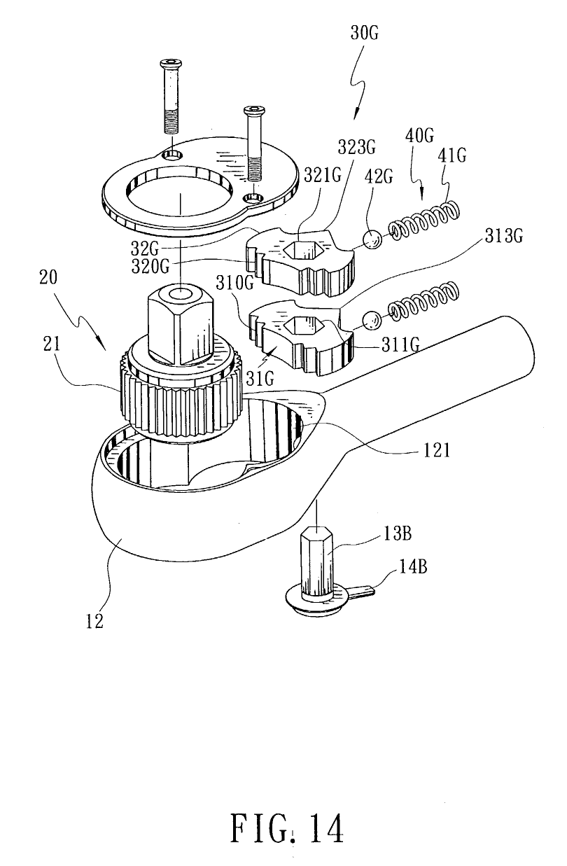

Referring to FIG. 14, in accordance with a eighth embodiment of the present invention, the wrench comprises a locking device 30G mounted in the driving recess 121 and including a first driving block 31G and a second driving block 32G laminating each other. Each of the first driving block 31G and the second driving block 32G has a first side formed with two spaced toothed locking end 310G and 320G engaged with the locking teeth 21 of the drive member 20 and a second side formed with a convex direction changing portion 313G and 323G urged on a restoring member 40G which includes a ball-shaped push member 42G urged on the direction changing portion 313G and 323G and an elastic member 41G urged on the push member 42G and the wall of the driving recess 121. Each of the first driving block 31G and the second driving block 32G is formed with a hexagonal positioning recess 311G and 321G. In addition, the wrench further comprises a hexagonal urging block 13B inserted into the positioning recess 311G and 321G of each of the first driving block 31G and the second driving block 32G for rotating the first driving block 31G and the second driving block 32G, and a direction control knob 14B pivotably mounted on the drive head 12 and secured on the urging block 13B for rotating the urging block 13B.

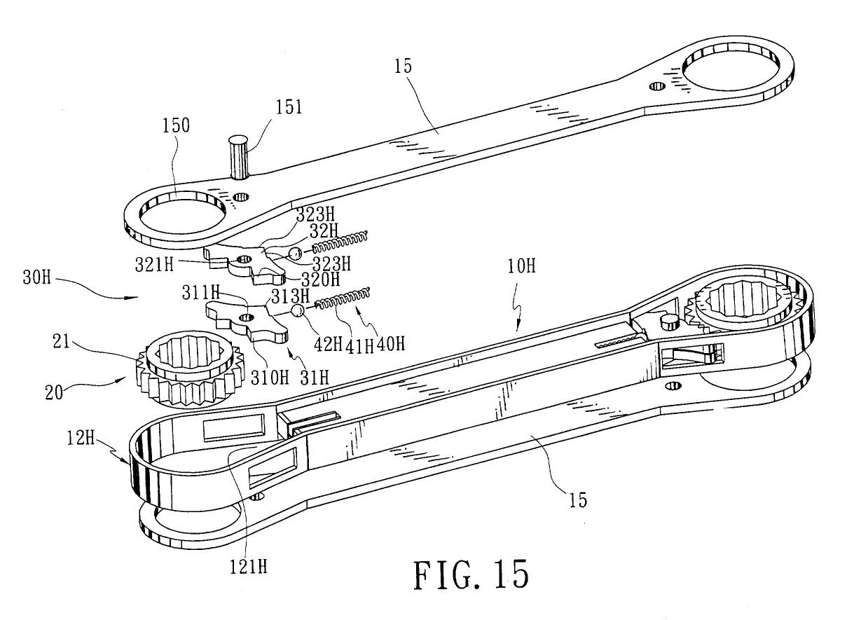

Referring to FIG. 15, in accordance with a ninth embodiment of the present invention, the wrench 10H comprises a locking device 30H mounted in the driving recess 121H and including a first driving block 31H and a second driving block 32H laminating each other. Each of the first driving block 31H and the second driving block 32H has a first side formed with two spaced toothed locking end 310H and 320H engaged with the locking teeth 21 of the drive member 20 and a second side formed with a convex direction changing portion 313H and 323H urged on a restoring member 40H which includes a ball-shaped push member 42H urged on the direction changing portion 313H and 323H and an elastic member 41H urged on the push member 42H and the wall of the driving recess 121H. Each of the first driving block 31H and the second driving block 32H is formed with a positioning hole 311H and 321H. In addition, the wrench 10H further comprises an elongated cover 15 mounted on the top and bottom of the wrench 10H and having two ends each formed with a through hole 150, and a pivot axle 151 extended through the cover 15 and the positioning hole 311H and 321H of each of the first driving block 31H and the second driving block 32H for pivoting the first driving block 31H and the second driving block 32H.

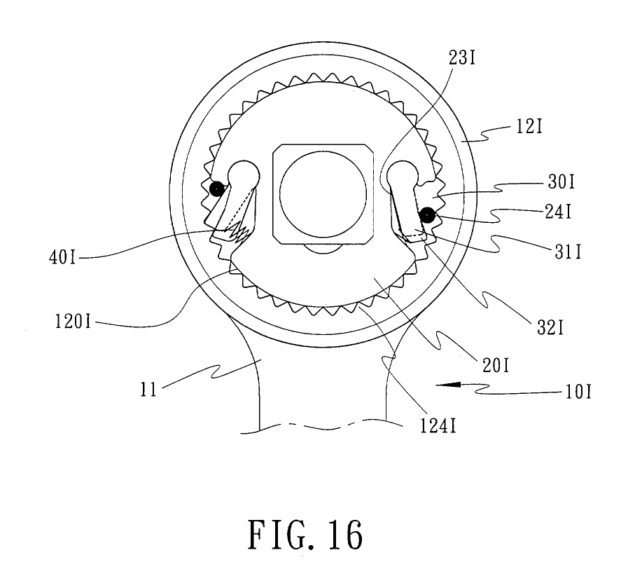

Referring to FIG. 16, in accordance with a tenth embodiment of the present invention, the wrench 10I comprises a drive head 12I formed with a receiving recess 120I having a wall formed with a plurality of locking teeth 124I, a drive member 20I having an outer wall formed with two driving recesses 23I, two locking devices 30I each mounted in a respective one of the two driving recesses 23I and each including a first driving block 31I and a second driving block 32I laminating each other, two restoring members 40I each urged between a respective one of the two locking devices 30I and a wall of the respective driving recess 23I, and two direction control knobs 24I each mounted on the drive member 20I to control the driving direction of the respective locking device 30I.

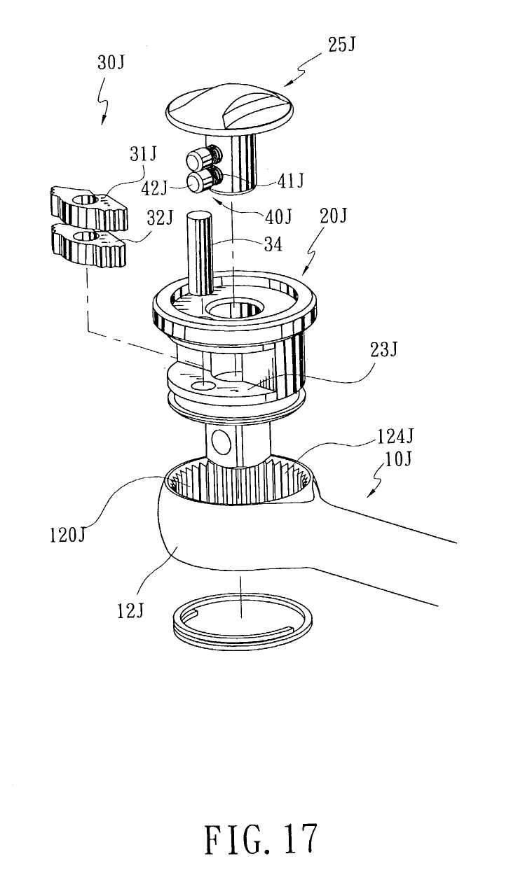

Referring to FIG. 17, in accordance with a eleventh embodiment of the present invention, the wrench 10J comprises a drive head 12J formed with a receiving recess 120J having a wall formed with a plurality of locking teeth 124J, a drive member 20J having a wall formed with a driving recess 23J, a locking device 30J mounted in the driving recess 23J and including a first driving block 31J and a second driving block 32J laminating each other, a pivot shaft 34 extended through the drive member 20J, the first driving block 31J and the second driving block 32J, a direction control knob 25J rotatably mounted on the drive member 20J to control the driving direction of the locking device 30J, and two restoring members 40J each including a push member 42J urged on the first driving block 31J and the second driving block 32J and an elastic member 41J urged between the push member 42J and the direction control knob 25J.

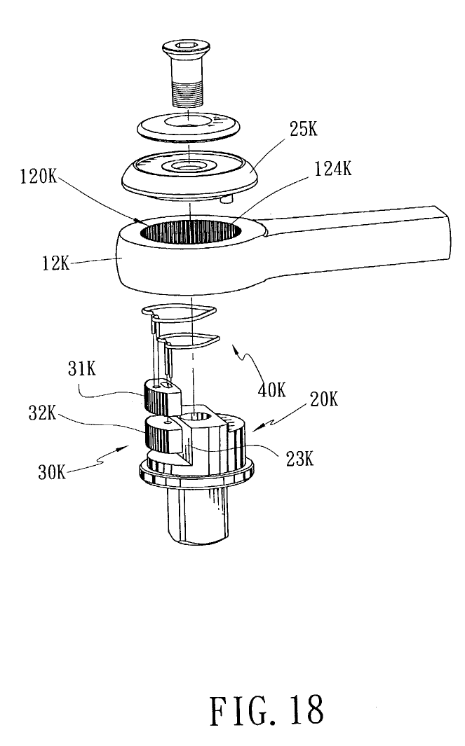

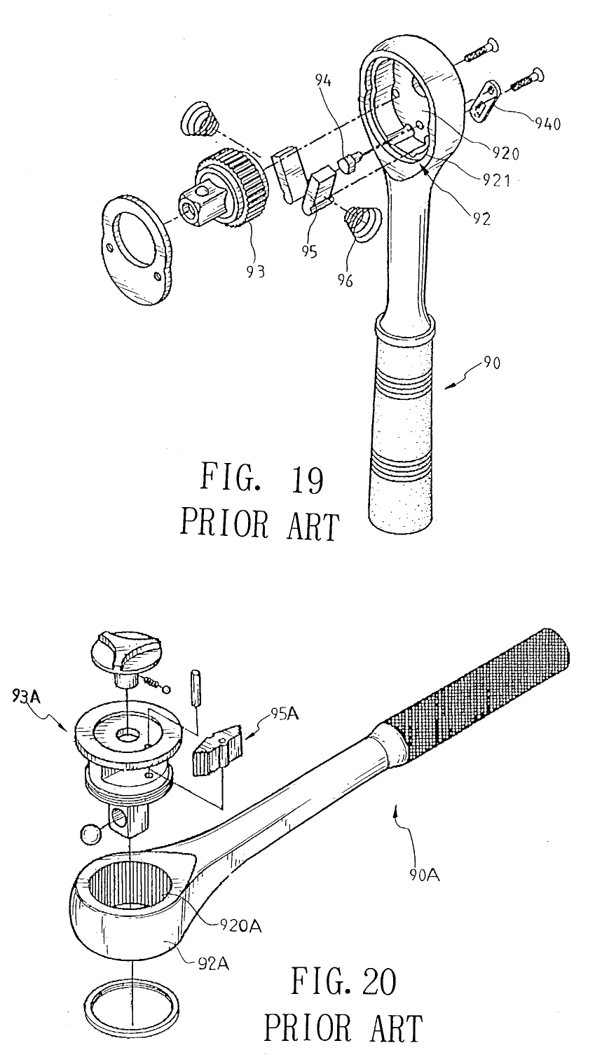

Referring to FIG. 18, in accordance with a twelfth embodiment of the present invention, the wrench comprises a drive head 12K formed with a receiving recess 120K having a wall formed with a plurality of locking teeth 124K, a drive member 20K having a wall formed with a driving recess 23K, a locking device 30K mounted in the driving recess 23K and including a first driving block 31K and a second driving block 32K laminating each other, a direction control knob 25K rotatably mounted on the drive member 20K to control the driving direction of the locking device 30K, and two restoring members 40K each mounted between the direction control knob 25K and a respective one of the first driving block 31K and the second driving block 32K, so that each of the two restoring members 40K is rotated by the direction control knob 25K to pivot the first driving block 31K and the second driving block 32K.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench, comprising:
a drive head;
a drive member mounted in an inner wall of the drive head;
a plurality of locking teeth mounted on either one of the inner wall of the drive head and the drive member; and
at least one locking device mounted on either one of the inner wall of the drive head and the drive member and engaged with the locking teeth to drive the drive member, wherein:
the at least one locking device includes at least two independent driving blocks laminating each other;
each of the at least two driving blocks is formed with a locking end and a positioning portion, the locking end is engageable with the locking teeth; and
the locking ends of the at least two driving blocks are respectively engaged with the locking teeth at different time.

2. The wrench in accordance with claim 1, wherein the locking teeth are formed on the drive member, and the at least one locking device is mounted on the inner wall of the drive head.

3. The wrench in accordance with claim 1, wherein the locking teeth are formed on the inner wall of the drive head, and the at least one locking device is mounted on the drive member.

4. The wrench in accordance with claim 1, wherein the locking ends of the at least two driving blocks have different lengths.

5. The wrench in accordance with claim 1, wherein the locking end of a first one of the at least two driving blocks is protruded outward from the locking end of a second one of the at least two driving blocks with a length difference equal to a half of the tooth pitch of each of the locking teeth.

6. The wrench in accordance with claim 2, further comprising at least one restoring member urged between the at least one locking device and the inner wall of the drive head.

7. The wrench in accordance with claim 3, further comprising at least one restoring member urged between the at least one locking device and the drive member.

8. The wrench in accordance with claim 1, further comprising an urging block mounted in a driving recess in the inner wall of the drive head, and a direction control knob pivotably mounted on the drive head and connected to the urging block for rotating the urging block to press the locking device, and the locking device is located on each of two sides of the urging block.

9. The wrench in accordance with claim 1, wherein the positioning portions of the at least two driving blocks are co-axial and are rotatably mounted in an arcuate positioning recess in the inner wall of the drive head.

10. The wrench in accordance with claim 1, wherein the positioning portion of each of the at least two driving blocks is urged on a restoring member, and the wrench further comprises a threaded seal cover screwed into an inner thread of a driving recess in the inner wall of the drive head and urged on the restoring member.

11. The wrench in accordance with claim 1, wherein the locking device includes a first driving block and a second driving block each having a first side formed with two spaced toothed locking ends and a second side formed with a positioning portion urged on a restoring member which includes a ball-shaped push member urged on the positioning portion and an elastic member urged on the push member and the inner wall of the drive head.

12. The wrench in accordance with claim 11, wherein each of the first driving block and the second driving block has two ends each protruding outward from the drive head.

13. The wrench in accordance with claim 11, further comprising an urging block rotatably mounted in the drive head and formed with two receiving holes for receiving the restoring member, and a direction control knob pivotably mounted on the drive head and secured on the urging block for rotating the urging block.

14. The wrench in accordance with claim 1, wherein the locking device includes a first driving block and a second driving block each formed with a positioning recess and each having a first side formed with two spaced toothed locking ends and a second side formed with a direction changing portion urged on a restoring member which includes a ball-shaped push member urged on the positioning portion and an elastic member urged on the push member and the inner wall of the drive head, and the wrench further comprises an urging block inserted into the positioning recess of each of the first driving block and the second driving block.

15. The wrench in accordance with claim 14, further comprising a direction control knob pivotably mounted on the drive head and secured on the urging block.

16. The wrench in accordance with claim 14, further comprising an elongated cover mounted on the top and bottom of the wrench and having two ends each formed with a through hole.

17. The wrench in accordance with claim 1, wherein the drive head is formed with a receiving recess having a wall formed with a plurality of locking teeth, the drive member has a wall formed with a driving recess, the locking device is mounted in the driving recess and includes a first driving block and a second driving block laminating each other, a direction control knob is rotatably mounted on the drive member to control the driving direction of the locking device, and two restoring members each mounted between the direction control knob and a respective one of the first driving block and the second driving block, so that each of the two restoring members is rotated by the direction control knob to pivot the first driving block and the second driving block.

18. The wrench in accordance with claim 1, wherein the locking device includes a U-shaped first driving block and a T-shaped second driving block laminating each other, the first driving block has a locking end and two positioning portions, the second driving block has a locking end and a positioning portion pivotally mounted between the two positioning portions of the first driving block.
